(19) United States
(12) Patent Application Publication
(10) Pub. No.: US 2025/0143947 A1
(43) Pub. Date: May 8, 2025

(54) HOSPITAL BED HEAD RESTING APPARATUS AND PRESSURE RELIEF HEADREST

(71) Applicant: Ahmed Abdelaal Ahmed Mahmoud Metwally ALKHATIP, Birmingham (GB)

(72) Inventor: Ahmed Abdelaal Ahmed Mahmoud Metwally ALKHATIP, Birmingham (GB)

(21) Appl. No.: 18/500,139

(22) Filed: Nov. 2, 2023

(51) Int. Cl. A61G 13/12

(52) U.S. Cl. CPC A61G 13/121; A61G 13/1265

(57) ABSTRACT

Disclosed herein is a head resting apparatus for a patient. The apparatus comprises one or more head rings each of the head rings having an inflatable compartment connected to an inflation device that inflates and deflates the head rings in an alternate manner such that alternate pressure is distributed on different parts of the patient's head in a given time duration. A head ring may be provided that is divided into even number of sections that are alternatively inflated and deflated by the inflation device for preventing pressure ischemia and alopecia in patients.

### FIELD OF THE INVENTION

The present disclosure is generally directed to the field of medical support devices. Particularly, the present invention relates to a head resting apparatus for supporting a patient's head and preventing pressure ischemia in the scalp.

### BACKGROUND

In various medical scenarios, a headrest is required to support a head of a patient while they are undergoing a medical treatment. The patient may be under general anesthesia and undergoing a long surgery, or they may be too ill to move their head, or they may be critically injured trauma patients, or they may be bed ridden, etcetera.

A headrest may be provided during these scenarios to support the head of the patient, for instance, during a surgery. The headrest is made of solid soft materials such as silicon to provide cushioned support. During a long surgery and/or further long intensive care stay the same area of the patient's head may rest on the headrest. This can give rise to pressure ischemia in the scalp in this area.

Pressure ischemia may lead to swelling, tenderness, and ulceration of the scalp. It may lead to loss of scalp hair known as alopecia. These effects may manifest as in the first few postoperative days. Often, patients may first present with alopecia, accompanied by a recent history of scalp immobilization in the preceding weeks.

Existing head rings provide support to the patients' head can cause pressure ischemia and the associated deleterious effects. A discussion of medical incidence may be found for example in the article “Pressure Alopecia” by Kate E. Davies and PD Yesudian, Department of Dermatology, Ysbyty Glan Clwyd, Denbighshire, International Journal of Trichology, 2023, April-June; 4(2) 64-58.

Thus, there is a need for a means to support a head of a patient while they are undergoing medical treatment or otherwise require prolonged head support.

### SUMMARY OF THE INVENTION

According to a first aspect of the invention there is a bed head resting apparatus comprising: an inflatable headrest with at least a first and a second inflatable compartment to support a patient's head away from the surgical bed, and an inflation device to alternatively inflate and deflate the first and the second inflatable compartment respectively.

Preferably the head resting apparatus is a surgical bed head resting apparatus or a hospital bed head resting apparatus to alleviate pressure ischemia on a patient's head during a prolonged surgery while they are under anesthesia and their head is still.

According to a second aspect of the invention there is surgical bed kit comprising a surgical bed and the surgical bed head resting apparatus. According to a third aspect of the invention there is surgical bed comprising the surgical bed head resting apparatus. The surgical bed head resting apparatus may be temporally place on the surgical bed, or the surgical bed head resting apparatus may be permanently attached.

According to a fourth aspect of the invention there is a surgical bed comprising an inflatable headrest with at least a first and a second inflatable compartment to support a patient's head away from the surgical bed, wherein each inflatable compartment comprises fluid connectors to connect to an inflation device of a surgical bed head resting apparatus.

The inflation device may be configured to adjust the air pressure individually in each inflatable compartment. By varying the air pressure in each inflatable compartment separately, each inflatable compartment may support the patient's head at a different time in a different area. Pressure on different areas of the patient's head is varied according to where each of the inflatable compartments supports the patient's head.

In this way the surgical bed head resting apparatus inflatable headrest prevents pressure ischemia during a long surgery and further long intensive care stay. This patient recovers without suffering swelling, tenderness, ulceration of the scalp, and alopecia where their head was supported by the surgical bed head resting apparatus.

The inflatable headrest may comprise a round or multisided pillow and/or the inflatable head rest may comprise a doughnut shaped head ring. The inflatable headrest may be a floppy uninflated shape until inflated to take on the inflated shape of the pillow or head ring. The patient's head may then be robustly supported by concavity of the pillow shape or partially within the doughnut hole. The part of the patient's head in the inner space or doughnut hole has no contact with the inflatable headrest and is raised above the surgical bed by the head ring. The part of the patient's head in the inner space or doughnut hole is free of contact pressure and so free of pressure ischemia.

Preferably when inflated, the inflatable headrest comprises at least a first head ring surrounding an inner space to receive the patient's head. The first inflatable compartment may be inflatable to form the first head ring.

At least the first and the second inflatable compartment may be inflatable in formation of the first head ring. The part of the patient's head supported by the first head ring is alternately supported by the first inflatable compartment and the second inflatable compartment to prevent pressure ischemia. The first head ring is divided into inflatable compartments including the first and second inflatable compartments, wherein a first group of the inflatable compartments is configured to be inflated by the inflation device as a second different group of the inflatable compartments is deflated by the inflation device, there after the first group being deflated while the second different group is inflated, to distribute alternate pressure on different parts of the patient's head.

There may be a surgical bed head resting apparatus comprising: an inflatable head rest comprising at least first and second inflatable compartments to form a first head ring when inflated to support a patient's head away from the surgical bed; and an inflation device to alternately inflate and deflate at least the first inflatable compartments and then at least the second inflatable compartments to continuously provide ring shape support.

The first and the second inflatable compartments may be inflatable to be angularly distant from each other. The inflatable headrest may comprise first and second semicircular inflatable compartments. The inflation device may alternatively inflate and deflate the two halves' sections of the first head ring aiming to have one section inflated at a single time.

The first inflatable compartment may span an angle of zero to one hundred and eighty degrees. The first inflatable compartment may span an angle of one hundred and eighty degrees to three hundred and sixty degrees. The first and second inflatable compartments may form a first head ring which may be circular or oval to support the patient's head.

Preferably there are more inflatable compartments to provide more variation and robust support for the patient's head. There may be three, four, five, six, or more inflatable compartments angularly distant from each other.

The head resting apparatus may comprise: a head ring, e.g. a first head ring to support the patient's head, divided into a number more than two of the inflatable compartments. A first half of the inflatable compartments may be inflated at a time while a remaining half of the inflatable compartments are deflated. Thereafter the first half of the inflatable compartments may be deflated while the remaining half of the inflatable compartments are deflated. The first half of inflatable compartments may alternate physical positions with the second half of the inflatable compartments. Each inflatable compartment of the first half may be interspersed between two of the inflatable compartments of the second half. The first head ring may be connected to an inflation device that alternatively inflates and deflates each of the half alternates of the sections at a single time, to thereby distribute alternate pressure on different parts of the patient's head.

In an inflatable headrest comprising six inflatable compartments, the first inflatable compartment may span 0 to 60 degrees, the second inflatable compartment may span 60 to 120 degrees, the third inflatable compartment may span 120 to 180 degrees, the fourth inflatable compartment may span 180 to 240 degrees, the fifth inflatable compartment may span 240 to 300 degrees, the sixth inflatable compartment may span 300 to 360 degrees. The first head ring is thereby formed by six arc sections formed by the six inflatable compartments. The inflation device may inflate the first, third, and fifth inflatable compartments, and deflate the second, fourth, and sixth inflatable compartment. Then the inflation device may deflate the first, third, and fifth inflatable compartments, and inflate the second, fourth, and sixth inflatable compartment. By alternately inflating these sets of compartments the patient's head is alternately supported by the first, third, and fifth inflatable compartments, and then the second, fourth, and sixth inflatable compartments. Pressure on different areas of the patient's head is alternated according to where each of the inflatable compartments supports the patient's head. In this way the surgical bed head resting apparatus inflatable headrest prevents pressure ischemia on single area, and this patient recovers without suffering swelling, tenderness, ulceration of the scalp, and alopecia where their head was supported by the surgical bed head resting apparatus.

The angular span of the inflatable compartments may be different from each other. For example the first inflatable compartment may span 0 to 20 degrees; the second inflatable compartment may span 20 to 170 degrees; the third inflatable compartment may span 170 to 270 degrees; the fourth inflatable compartment may span 270 to 350 degrees.

A solid or flexible non-inflatable connector may connect inflatable compartments to render the inflatable headrest contiguous. For example, a solid or flexible non-inflatable connector may connect the fourth inflatable section to the first inflatable section to complete the first head ring.

The first and the second inflatable compartments and/or all the inflatable compartments may be inflatable to be radially distant from each other. The inflatable headrest may comprise a second head ring surrounding the first head ring, wherein the first head ring is inflatable to support the patient's head when the second head ring is deflated, and the second head ring is inflatable to support the patient's head when the first head ring is deflated. The first inflatable compartment may be inflatable to form the first head ring and the second inflatable compartment may be inflatable to form the second head ring.

The surgical bed head resting apparatus may comprise: an inflatable head rest comprising at least a first inflatable compartment to form a first head ring when inflated to provide an inner ring shape support to the head of a patient, and at least a second inflatable compartment to form a second head ring when inflated that surrounds the first head ring to provide an outer ring shape support to the head of the patient; and an inflation device to alternately inflate and then deflate at least the first inflatable compartment(s) to form the first head ring and then at least the second inflatable compartment(s) to form the second head ring to continuously provide ring shape support.

The second head ring may be an outer inflatable ring so that it is radially outward compared to the first head ring. The first head ring may be an inner inflatable ring disposed inside the second head ring such that the second head ring surrounds the first head ring. Each of the first head ring and the second head ring may be fluidically connected to the inflation device configured to alternately inflate and deflate the first head ring and the second head ring to distribute alternate pressure on different parts of the patient's head.

The first head ring and the second head ring may be coupled together by a restraint connected to both the first and second head rings. The restraint may hold the first head ring in position within the doughnut hole space of the second head ring such that the second head ring surrounds the first head ring when both rings are inflated. The restraint may or may not fluidically connect an inflatable compartment in the first head ring to an inflatable compartment in the second head ring.

The first head ring and the second head ring may not be directly connected to each other. They may only be indirectly connected by a first tubing that connects the first head ring to the inflation device and a second tubing that connects the second head ring to the inflation device.

The first and/or second tubing may be flexible like string to allow a doctor or nurse on the hospital team to easily move the first head ring and/or the second ring to a position on or away from the surgical bed that is convenient for the hospital team or the patient. The first and second flexible tubings may not hold the first head ring or the second head ring in place. So a person on the hospital team may be required to place the first head ring within a doughnut hole space of the second head ring. Then the doctor or nurse may lift the patient's head onto the inflatable headrest so that the patient's head is supported by the first and second head rings as they are alternately inflated.

The inflatable compartments may comprise a membrane inflatable to a form a smooth surface upon which to rest and support the patient's head. The smooth surface does not have bumps where pressure on the patient's scalp could be intensified and cause pressure ischemia. The inflatable compartments may comprise expandable balloon like membranes. The membranes may be pre-formed with a pillow, ring, or doughnut shape. They membranes may be floppy disheveled shape until they are inflated to take on the pillow, ring, or doughnut shape. The membranes may comprise a stretchable material which stretches when inflated to form a smooth surface upon which the patient's head is rested.

In the surgical bed head resting apparatus the inflatable compartments may be fluidically connected to each other in separate groups, and the inflation device is separately fluidically connected to each group to alternately inflate each group of inflatable compartments. The inflation device may be configured to inflate each of the inflatable compartments one at a time. The inflation device may be configured to inflate preselected groups of the inflatable compartments one at a time.

Preferably the inflation device is configured to use ambient air in the vicinity of the surgical bed head resting apparatus to inflate the inflatable compartments. The inflation device may comprise an air compressor. The inflation device may use a compressor from a double tourniquet device in a medical operating room or theater where the surgical bed is located. As an alternative, or in conjunction with the compressor, the inflation device may be configured to use bottled compressed air or a compressed air supply outlet to inflate the inflatable compartments.

Preferably the inflation device comprises adjustable settings to set a time duration for inflation and deflation. This limits the time duration of pressure on the patient's head where each inflatable compartment of the inflatable headrest supports the patient's head.

The inflation device may comprise an automatic controller to automatically control inflation and deflation of the compartments once set. The inflation device may comprise manual means to manually control inflation and deflation of the compartments. The maximum pressure on inflation, the minimum pressure on deflation, the time from maximum pressure to minimum pressure, and the rate of inflation and deflation may be controlled in this way.

The minimum pressure may be zero bar, i.e. ambient air pressure. The minimum pressure may be in a range between zero bar and one bar. The maximum pressure may be in a range of 0.5 bar to three bar, preferably in a range of one bar to two bar.

The maximum pressure is preferably at least 0.5 bar greater than the minimum pressure. This difference between the minimum and maximum pressures ensures the patient's head is supported only or primarily on the inflated inflatable compartment(s) and not or less on the deflated inflatable compartment(s).

The minimum pressure is preferably zero bar to avoid having a partially inflated ring or inflatable compartment that will have wrinkles and may cause pressure injury.

The inflation device may be configured to inflate the inflatable compartments whereby the inflated compartments at once provide a circular support to the head of the patient. As explained previously, the inflatable compartments when inflated may form one or more ring shaped headrests.

At least the first and the second inflatable compartment may be inflatable in formation of the first head ring and/or second head ring whereby the inflatable compartments when inflated at once provide a support to the head of the patient.

Tubing and/or ducting may fluidically connect the inflation device to the inflatable compartments. The tubing and/or ducting may comprise a first tubing and a second tubing which may be flexible as previously described above or at least portions of the lengths of the first and second tubing may be flexible. The first flexible portion of the tubing may fluidically connect one or more inflatable compartments in a first group including the first inflatable compartment in the first head ring to the inflation device. The second flexible tubing may fluidically connect one or more inflatable compartments in a second group including the second inflatable compartment in the second head ring to the inflation device. The second head ring may be of greater diameter than the first head ring when inflated. The first head ring may be placeable on a surgical bed by a doctor or nurse within a doughnut hole space of the second head ring. The first and second head rings may be placeable relative to each other and relative to the inflation device by virtue of the flexibility of the first and second flexible tubings.

As part of the ducting, the surgical bed head resting apparatus may comprise separate plenums each fluidically connected to the inflation device and the inflatable compartments in a respective one of the groups. The separate plenums include a first plenum surrounded by the first head ring and a second plenum surrounding the first head ring.

Said tubing and or ducting may comprise a first plenum that is ring shaped or circular to conform with the first head ring and/or be surrounded by the first head ring. The first plenum may be fluidically connected to one or more inflatable compartments in a first group of inflatable compartments including the first inflatable compartment. The tubing may comprise a second plenum that is ring shaped or circular to conform with and/or surround the first head ring. The second plenum may be fluidically connected to one or more inflatable compartments in a second group of inflatable compartments including the second inflatable compartment. The first and second inflatable compartments may be angularly offset from each other in the first head ring. The first and second groups of inflatable compartments may be angularly offset and interspersed with respect to each other.

The inflatable headrest may comprise a camera with a low-heat producing light source such as an LED. The camera may be used to get a picture with inflation and deflation to be sure the head and neck parts are ok (not compressed or the head is not moved etc.).

Materials in the inflatable headrest may be hypoallergic. Non limiting examples of such materials include PVC or silicone. A stretchable polyurethane or polyurethane gel compound may be used. Preferable materials enable the inflatable compartments to expand when inflated so that the inflatable headrest does not have any wrinkles when inflated. Preferable materials enable the inflatable compartments to contract when deflated so that they remove pressure of inflatable headrest where they are deflated.

The invention will now be described, by way of example only, with reference to the accompanying figures in which:

### BRIEF DESCRIPTION OF THE FIGURES

FIG. 1 illustrates a surgical bed head resting apparatus comprising radially separated first and second head rings having inflatable compartments connected by flexible tubing to an inflation device;

FIG. 2 illustrates a surgical bed head resting apparatus comprising a first head ring comprising angularly separated inflatable compartments supplied by plenums rings fluidically connected by flexible tubing to an inflation device; and

FIG. 3 illustrates a surgical bed comprising a surgical bed head resting apparatus.

### DETAILED DESCRIPTION OF THE INVENTION

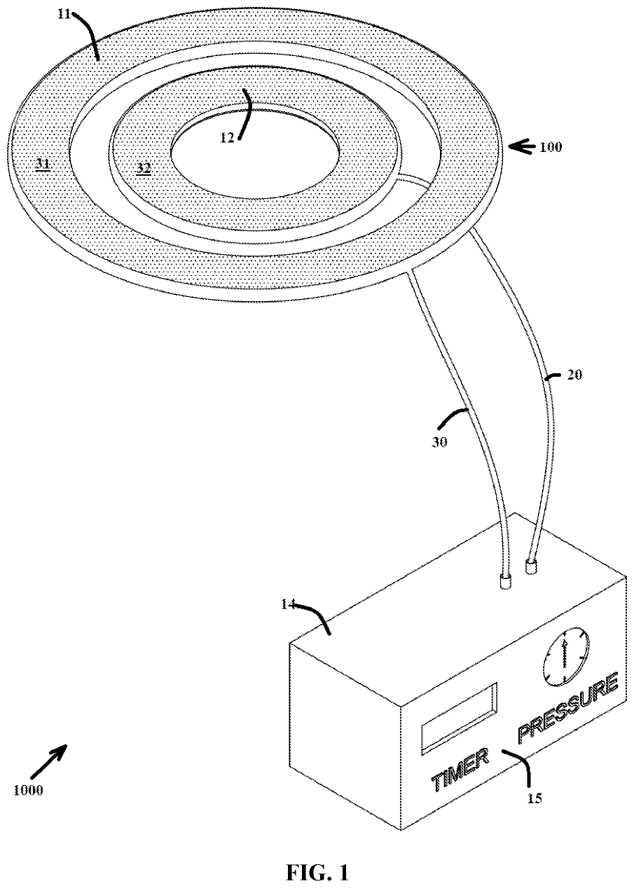

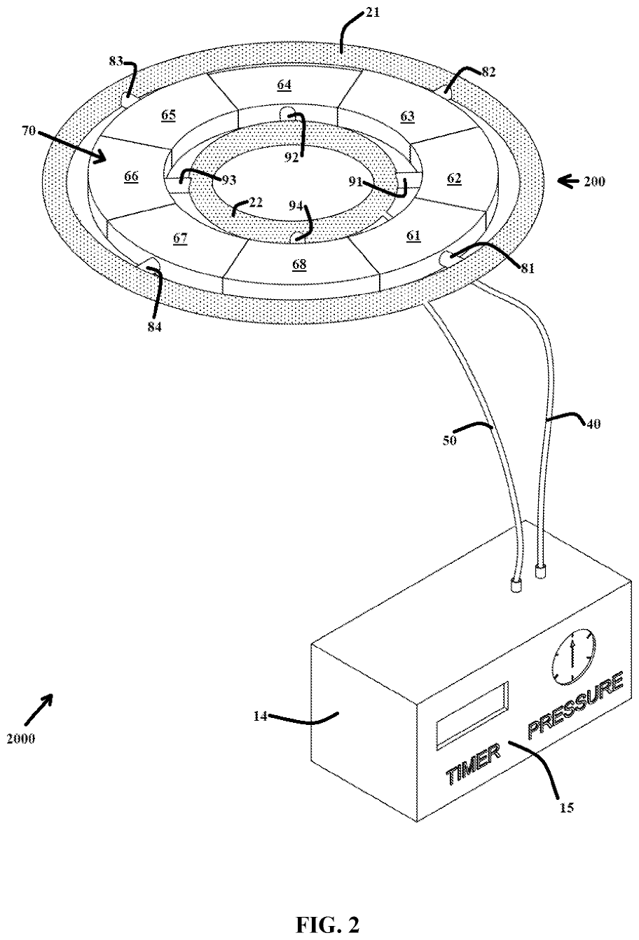

Referring to the Figures, there are shown a first embodiment 1000 and a second embodiment 2000 in FIGS. 1 and 2 respectively of a surgical bed head resting apparatus for supporting a patient's head above a surgical bed.

The surgical bed head resting apparatus 1000, 2000 comprises: an inflatable headrest 100, 200 with at least a first 32, 62 and a second 31, 61 inflatable compartment to support a patient's head away from the surgical bed, and an inflation device 14 to alternatively inflate and deflate the first 32, 62 and the second 31, 61 inflatable compartment respectively. The inflation device 14 could use room air to inflate the head rings 11, 12 and could release the deflated air to room air. The inflation/deflation devices are known in medical practice and are used for double tourniquet.

In the first embodiment of the surgical bed head resting apparatus 1000 shown in FIG. 1, the first head ring 12 is an inner head ring adapted towards the inner circumference of the second head ring 11 which is an outer head ring. Within the first head ring 12 is the first inflatable compartment 31 by which the first head ring 12 is inflated.

In the first embodiment of the surgical bed head resting apparatus 1000 there is a second head ring 11. The second head ring 11 surrounds the first head ring 12. Within the second head ring 11 is the second inflatable compartment 32 by which the second head ring 12 is inflated.

Each of the second head ring 11 and the first head ring 12 is connected to the inflation device 14 that alternatively inflates and deflates each of the first head ring 12 and the second head ring 11 at a single time, to thereby distribute alternate pressure on different parts of the patient's head. The inflation device 14 pumps air in and out to inflate and deflate the head rings 11, 12 one by one.

As shown in FIG. 1, the first and second head rings 12, 11 are substantially concentric, though not exactly so because there is no restraint device holding the first and second head rings 12, 11 in position relative to each other. This allows the relative position of the head rings 12, 11 to be adjusted on the surgical bed according to the individual shape of the patient's head.

During a prolonged surgical operation a patient's head is rested on the head rings 11, 12. The head rings 11, 12 are connected to an inflation device 14 by tubing 20, 30 that inflates and deflates inflatable compartments in the head rings 11, 12. This inflates and deflates the head rings 11, 12 in an alternate manner such that alternate pressure is distributed on different parts of the patient's head in a given time duration. This prevents pressure ischemia and alopecia in the patient's scalp by preventing a harmfully long duration of pressure one area of the patient's scalp.

It is possible for the surgical bed head resting apparatus 1000 to comprise more head rings than just the first and head rings 12, 11. There could be a third head ring surrounding the second head ring 11. The third head ring would also have an inflatable compartment fluidically connected to the inflation device 14 to be alternately inflated and deflated with respect to the first and second head rings 12, 11.

The process of inflation and deflation may be done and controlled (in pressure, rate and time) by using a control panel 15 on the inflation/deflation device 14. The inflation device 14 is provided with configurable settings which may be set via the control panel 15 or a remote control to set a time duration for inflation and deflation as required by according to clinical need and circumstances. The control panel 15 also facilitates in setting required pressure for inflating the inflatable compartments in the head rings 11, 12.

The pressure and the time of inflation is displayed on the control panel 15. The inflation device 14 controls inflation and deflation of the inner head ring 12, and the outer head ring 11 in automated mode or by using manual controls. The inflation device 14 is provided with the control panel 15 that includes various settings, such as push buttons, touch buttons, knobs, sliders etcetera, for allowing the users to configure the settings according to their requirements. A timer and a pressure meter may be provided to set the timings and inflation and deflation pressure of the head rings 11, 12.

The surgical bed head resting apparatus 1000, 2000 allows pressure applied to any area of the scalp to be limited to only a short period of time. The time of inflation/deflation of each inflatable compartment in each of the first and second head rings 11, 12 is initially set to a few minutes (for example, 30 minutes) but can be adjusted as per clinical need and circumstances. The inflation device 14 controlling the pressure (i.e., inflation/deflation pressure) of both head rings 11, 12 is automated and can also allow manual or direct control and adjustment.

The limited time of applying pressure on the scalp helps prevent pressure ischemia/alopecia. This means the pressure on the head is not constant and it is redistributed every preset time interval, for example, 30-minutes to 60-minutes between different areas of the head. This helps the patients to rest their head without having the risk of pressure sore and alopecia.

In the first embodiment of the surgical bed head resting apparatus 1000 shown in FIG. 1, each of the head rings 11, 12 is in contact with, and applies pressure over, a certain area of the head that is different to the area in contact with the other head ring. The design allows pressure applied to any area of the scalp to be limited to a short period of time as set by the user or by default. The limited time of applying pressure on the scalp helps prevent pressure ischemia/alopecia in the patients. Each inflatable compartment of the head ring is in contact with, and applies pressure over, a certain area of the head that is different to the area in contact with the other inflatable compartments of the same head ring.

In the second embodiment of the surgical bed head resting apparatus 2000 shown in FIG. 2, the inflatable headrest 200 comprises a single head ring 70 that is divided into even alternating inflatable compartments 61, 62, 63, 64, 65, 66, 67, 68. Half of the inflatable compartments in a first group 62, 64, 66, 68 are inflated with air at the time when the other inflatable compartments 61, 63, 65, 67 are deflated. Thereafter the first half of the inflatable compartments are deflated, and the remaining half inflatable compartments are inflated at the same time. This process is repeated throughout the requirement of the patient or the person who needs to use the head rest. The inflatable compartments at one time provide circular support of the head. Both alternate inflatable compartments of the first head ring 70 are inflatable and connected to the inflation device 14 that may be an automated device or may be operated manually.

The inflation device 14 alternatively inflates and deflates the two inflatable compartments of the head ring aiming to have one inflatable compartment inflated at a single time. It is possible to have more than two groups of inflatable compartments. As one of many possibilities, there could be a first other group of two inflatable compartments 62, 64, a second other group of two inflatable compartments 61, 63, a third other group of two inflatable compartments 65, 67, and a fourth other group of two inflatable compartments 66, 68. Each other group could be sequentially inflated and deflated to ensure no one area of the patient's scalp is subjected to prolonged pressure by the inflatable headrest that could cause pressure ischemia.

In the second embodiment of the surgical bed head resting apparatus 2000 shown in FIG. 2, a single first head ring 70 is divided into a number of inflatable compartments 61, 62, 63, 64, 65, 66, 67, 68. The inflatable compartments are angularly separated and sequentially adjacent to each other around the first head ring 70. The inflatable compartments in the first head ring include a first inflatable compartment 62 angularly separate from and adjacent to a second inflatable compartment 61.

As shown in FIG. 2, tubing 40, 50, 81, 82, 83, 84 85, 86, 87, 88 and ducting 21, 22 fluidically connects the inflation device 14 to the inflatable compartments 61, 62, 63, 64, 65, 66, 67, 68 in the first head ring 70.

The ducting comprises a first plenum 22 and second plenum 21 fluidically connected to the inflation device 14 to receive pressurized air. The first plenum 22 and second plenum 21 are fluidically connected to the first head ring 70. The first plenum 22 and second plenum 21 evenly distribute the pressurized air to the inflatable compartments 61, 62, 63, 64, 65, 66, 67, 68.

The first plenum 22 is ring shaped or circular and dimensioned to conform with the inner circumference of the first head ring 70. The first plenum is surrounded by the first head ring 70 and disposed within the doughnut hole of the first head ring 70. The first plenum 22 is fluidically connected to four inflatable compartments 62, 64, 66, 68 in a first group including the first inflatable compartment 62. Four tubes 91, 92, 93, 94 transfer pressurized air between the four inflatable compartments 62, 64, 66, 68 in the first group to inflate and deflate them simultaneously and evenly.

The second plenum 21 is ring shaped or circular and dimensioned to conform with the outer circumference of the first head ring 70. The second plenum 21 surrounds the first head ring 70. The second plenum 21 is fluidically connected to four inflatable compartments 61, 63, 65, 67 in a second group including the second inflatable compartment 61. The each one of the four inflatable compartments 61, 63, 65, 67 in the second group is interspersed between two of the four inflatable compartments 62, 64, 66, 68 in the first group. Four tubes 81, 82, 83, 84 transfer pressurized air between the four inflatable compartments 61, 63, 65, 67 in the second group to inflate and deflate them simultaneously and evenly.

Two flexible tubes 40, 50 connect the first and second plenums 22, 21 to the inflation device 14 are for inflation and deflation. One end of each flexible tube 40, 50 is connected to the inflation/deflation device 14. The other end of each flexible tube is connected to the one of the first and second plenums 22, 21 of the inflatable headrest 200. The pair of flexible tubes 40, 50 facilitates in inflating and deflating of the inflatable compartments of the inflatable headrest as described above. Half the inflatable compartments 62, 64, 66, 68 to be inflated or deflated at one time are fluidically connected to one of the flexible tubes 40 and the other half of the inflatable compartments 61, 63, 65, 67 are fluidically connected to the other flexible tube 50.

The first group comprising half of the inflatable compartments 62, 64, 66, 68 are inflated at a time while remaining half in the second group of inflatable compartments 61, 63, 65, 67 are deflated. Thereafter, the first group of the inflatable compartments are deflated while the remaining second group of the inflatable compartments are inflated at another time. This is continuously repeated as long as the patient is required to lie on the surgical bed without moving their head. While the patient's head is supported on the inflatable headrest, the alternating inflation and deflation of the inflatable compartments alternates pressure on different parts of the patient's head.

Sizes of the inflatable headrest 100, 200 when inflated cover different sizes of patients' heads. Examples the dimensions of the inflatable headrest when inflated are:
Adult: 1.75″ (44.45 mm) H×8″ (203.2 mm) OD×3″ (76.2 mm) ID; or 8″ (203.2 mm) OD×4.5″ (114 mm) ID×1.75″ (44.4 mm) H;
Pediatric: 1.25″ (31.75 mm) H×5.5″ (139.7 mm) OD×2.25″ (57.15 mm) ID; and
Neonatal (Preemies): 0.75″ (19.05 mm) H×3.25″ (82.55 mm) OD×1.25″ (31.75 mm) ID; 4.5″ (114 mm) OD×2″ (50.8 mm) ID×1″ (25.4 mm) H.

Here, H is Height, OD is Outer Diameter, ID is Internal Diameter.

The above examples for measurements can be applied on the outer head ring 11 of the double ring inflatable headrest shown in FIG. 1, and on the single head ring 70 of the headrest 200 shown in FIG. 2. When inflated, the outer diameter of the inner first head ring 12 is slightly less (2 cm to 0.25 cm for example) than the inner diameter of the outer second head ring 11.

When uninflated, the inflatable compartments and head rings may contract to a thickness of 0.1 mm to 10 mm.

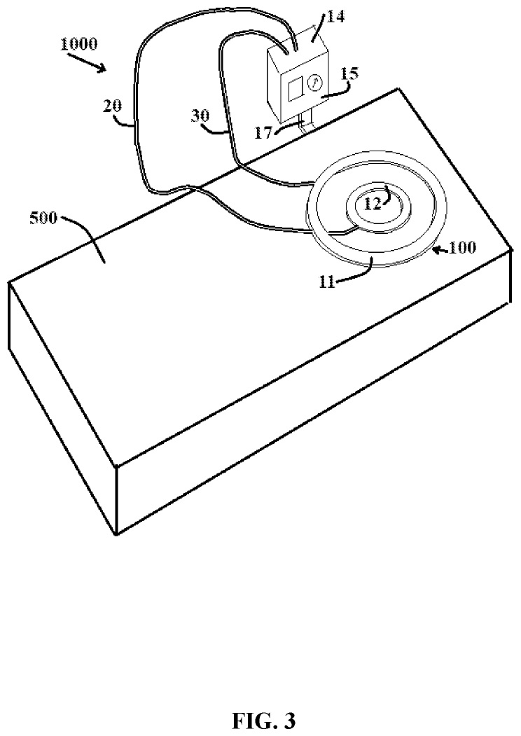

FIG. 3 shows a surgical or hospital bed 500 with a surgical or hospital bed head resting apparatus 1000. On the surgical bed 500 there is an inflatable headrest 100. The inflatable headrest 100 comprises a first inflatable compartment in a first head ring 12 and a second inflatable compartment in a second head ring 12 which surrounds the first head ring 11. When a patient is being operated upon on the surgical bed their head may rest for a long duration in the same position. Since the inflatable compartments are alternately inflated, the patient's head will be supported securely away from the surgical bed and pressure ischemia on same area of the patient's head will be avoided. Each inflatable compartment comprises fluid connectors 20, 30 to connect to the inflation device 14 of the surgical bed head resting apparatus 1000.

An inflatable headrest substantially as described herein with reference to the figures helps prevent pressure ischemia to a patient's scalp during surgery and other situations where otherwise an area of the scalp may experience prolonged pressure. This prevents subsequent soreness, swelling, ulceration and alopecia in this area.

### Index of Labelled Features in Figures

### 1^{st} Embodiment—FIG. 1

| | |
|---|---|
| control panel | 15 |
| first head ring | 12 |
| first inflatable compartment | 32 |
| head resting apparatus | 1000 |
| inflatable headrest | 100 |
| inflation device | 14 |
| second head ring | 11 |
| second inflatable compartment | 31 |
| tubing from inflation device to first head ring | 20 |
| tubing from inflation device to second head ring | 30 |

### 2^{nd} Embodiment—FIG. 2

| | |
|---|---|
| control panel | 15 |
| first group of inflatable compartments | 62, 64, 66, 68 |
| first head ring | 70 |
| first inflatable compartment | 62 |
| first plenum | 22 |
| head resting apparatus | 2000 |
| inflatable headrest | 200 |
| inflation device | 14 |
| second group of inflatable compartments | 61, 62, 63, 64 |
| second inflatable compartment | 61 |
| second plenum | 21 |
| tubes from first plenum to first group | 91, 92, 93, 94 |
| tubes from second plenum to second group | 81, 82, 83, 84 |
| tubing from inflation device to first group | 40 |
| tubing from inflation device to second group | 50 |

### FIG. 3

| | |
|---|---|
| support for inflation device | 17 |
| surgical or hospital bed with head resting apparatus | 500 |

The foregoing is considered as illustrative of the principles of the head resting apparatus. Further, since numerous modifications and changes will readily occur to those skilled in the art, it is not desired to limit the head resting apparatus to the exact construction and operation shown and described, and accordingly, all suitable modifications and equivalents may be resorted to, falling within the scope of the claims.

1. A surgical bed head resting apparatus comprising: an inflatable headrest with at least a first and a second inflatable compartment to support a patient's head away from the surgical bed, and an inflation device to alternately inflate and deflate the first and then the second inflatable compartment.

2. A surgical bed head resting apparatus according to claim 1 wherein the first and the second inflatable compartments are inflatable to be angularly distant from each other.

3. A surgical bed head resting apparatus according to claim 1 wherein the first and the second inflatable compartments are inflatable to be radially distant from each other.

4. A surgical bed head resting apparatus according to claim 1 wherein the inflation device is fluidically connected to the inflatable compartments to alternately inflate and deflate at least the first inflatable compartment and then at least the second inflatable compartment to continuously provide ring shape support.

5. A surgical bed head resting device according to claim 1 wherein the inflatable compartments comprise smooth membrane inflatable to a stretched smooth surface upon which to rest and support the patients head.

6. A surgical bed head resting device according to claim 1 wherein the inflation device comprises adjustable settings to set a time duration for inflation and deflation of each of the inflatable compartments to limit time of pressure on the patient's head where the inflatable headrest supports the patient's head.

7. A surgical bed head resting device according to claim 1 wherein inflation device comprises an automatic controller to automatically control inflation and deflation of the inflatable compartments.

8. A surgical bed head resting device according to claim 1 wherein inflation device comprises manual means to manually control inflation and deflation of the inflatable compartments.

9. A surgical bed head resting apparatus according to claim 1 comprising flexible tubing which fluidically connects the inflation device to the inflatable compartments and permits manual displacement of the inflatable headrest relative to the inflation device to position the headrest on the surgical bed.

10. A surgical bed head resting apparatus comprising: an inflatable head rest comprising at least first and second inflatable compartments to form a first head ring when inflated to support a patient's head away from the surgical bed; and an inflation device to alternately inflate and deflate at least the first inflatable compartment and then at least the second inflatable compartment to continuously provide ring shape support.

11. A surgical bed head resting apparatus according to claim 10 wherein the inflatable compartments are fluidically connected to each other in separate groups, and the inflation device is separately fluidically connected to each group to alternately inflate each group of inflatable compartments.

12. A surgical bed head resting apparatus according to claim 11 comprising separate plenums each fluidically connected to the inflation device and the inflatable compartments in a respective one of the groups.

13. A surgical bed head resting apparatus according to claim 12 wherein the separate plenums include a first plenum surrounded by the first head ring and a second plenum surrounding the first head ring.

14. A surgical bed head resting device according to claim 13 wherein the inflation device comprises adjustable settings to set a time duration for inflation and deflation of each group of the inflatable compartments to limit time of pressure on the patient's head where the inflatable headrest supports the patient's head.

15. A surgical bed head resting apparatus comprising: an inflatable head rest comprising
at least a first inflatable compartment to form a first head ring when inflated to provide an inner ring shape support to the head of a patient, and
and at least a second inflatable compartment to form a second head ring when inflated that surrounds the first head ring to provide an outer ring shape support to the head of the patient; and
an inflation device to alternately inflate and then deflate at least the first inflatable compartment(s) to form the first head ring and then at least the second inflatable compartment(s) to form the second head ring to continuously provide ring shape support.

16. A surgical bed head resting apparatus according to claim 15 comprising a first flexible tubing fluidically connecting the inflation device to the first head ring and a second flexible tubing fluidically connecting the inflation device to the second head ring to individually position the first and second head ring on the surgical bed.

17. A surgical bed kit comprising a surgical bed and a surgical bed head resting apparatus according to claim 1.

18. A surgical bed comprising a surgical bed head resting apparatus according to claim 1.
